(19) United States
(12) Patent Application Publication
(10) Pub. No.: US 2026/0225603 A1
(43) Pub. Date: Aug. 6, 2026

(54) DRIVING EVALUATION SYSTEM

(71) Applicant: Honda Motor Co., Ltd., Tokyo (JP)

(72) Inventor: Masayuki Sato, Saitama (JP)

(21) Appl. No.: 19/455,297

(22) Filed: Jan. 21, 2026

(30) Foreign Application Priority Data
Feb. 6, 2025 (JP) 2025-018024

(51) Int. Cl. B60W 50/14; B60W 40/09; G06Q 30/0207; H04W 4/48; B60W 40/08

(52) U.S. Cl. CPC B60W 50/14; B60W 40/09; G06Q 30/0207; H04W 4/48; B60W 2040/089; B60W 2050/143; B60W 2050/146; B60W 2540/21; B60W 2540/215; B60W 2556/45

(57) ABSTRACT

Driving evaluation system evaluating a driver of a vehicle traveling with a user based on information related to a driving action of the driver, includes: an in-vehicle device provided in the vehicle, and a communication terminal configured to detect behavior of the vehicle. The in-vehicle device is configured to perform: transmitting, to the first communication terminal, question information asking an impression of the user with respect to the driving action and receiving, from the first communication terminal, behavior information indicating behavior and answer information input by the user with respect to the question information; performing an evaluation on the driver based on the behavior information and answer information; selecting first content based on the result of evaluation and selecting second content according to driving actions of the driver before and after receiving provision of the first content; and providing the selected content to the driver.

### CROSS-REFERENCE TO RELATED APPLICATION

This application is based upon and claims the benefit of priority from Japanese Patent Application No. 2025-018024 filed on February 6, 2025, the content of which is incorporated herein by reference.

### BACKGROUND OF THE INVENTION

### Field of the Invention

The present invention relates to a driving evaluation system that evaluates driving of a driver.

### Description of the Related Art

As this type of technology, there is known a technology of detecting the presence or absence of an occupant in a vehicle and changing a notification method of a driving evaluation result based on a detection result (JP 2023-181870 A). The notification of the driving evaluation result is not made at the time the presence of an occupant in the vehicle is detected.

In general, it is important to notify the driver of the driving evaluation result in terms of giving notice to the driver. However, in the conventional technology, if presence of an occupant is detected, it is difficult to make the driver aware of a driving action that affects, for example, the riding comfort of the occupant.

Having the driver know the evaluation result of his/her driving action is expected to greatly contribute to traffic safety.

### SUMMARY OF THE INVENTION

An aspect of the present invention is a driving evaluation system configured to evaluate a driver of a vehicle traveling with a user based on information related to a driving action of the driver, including: an in-vehicle device provided in the vehicle and including a processor and a memory coupled to the processor; and a first communication terminal configured to detect a behavior of the vehicle and used by the user. The in-vehicle device is configured to perform: performing communication with the first communication terminal; through the communication, transmitting, to the first communication terminal, question information asking an impression of the user with respect to the driving action and receiving, from the first communication terminal, behavior information indicating the behavior and answer information input by the user with respect to the question information; performing evaluation on the driver based on the behavior information and the answer information; selecting a first content based on a result of the evaluation and selecting second content according to the driving actions of the driver before and after receiving provision of the first content; and providing the first content if the first content is selected and the second content if the second content is selected to the driver.

### BRIEF DESCRIPTION OF THE DRAWINGS

The objects, features, and advantages of the present invention will become clearer from the following description of embodiments in relation to the attached drawings, in which:

FIG. 1A is a schematic diagram illustrating an example of a driving evaluation system;

FIG. 1B is a schematic diagram illustrating an example of a vehicle equipped with an IVI system;

FIG. 2A is a block diagram illustrating a configuration of a main part of an in-vehicle device;

FIG. 2B is a block diagram illustrating a configuration of a main part of a vehicle sensor group and a vehicle interior camera;

FIG. 2C is a block diagram illustrating a configuration of a main part of an input device and an output device;

FIG. 2D is a block diagram illustrating a configuration of a main part of a terminal;

FIG. 3 is a flowchart for describing an example of a driving evaluation processing by a program; and

FIG. 4 is a block diagram illustrating a configuration of a main part of a server device.

### DETAILED DESCRIPTION OF THE INVENTION

### Overview

A driving evaluation system according to the invention evaluates a driver of a vehicle traveling with a user. More specifically, the evaluation on the driver is performed based on the behavior of the vehicle and the impression of the user on the driving action of the driver. The evaluated driver is provided with first content based on a result of the evaluation. The driver is further provided with second content according to driving actions before and after receiving the provision of the first content.

The first content is, for example, content for notifying the driver of advice for improving the driving action, such as “reduce speed at the time of turn”, “reduce accelerator opening”, and “gradually decelerate”.

The second content is, for example, content for notifying the driver that the driving action has improved if the evaluation result is improved after receiving the provision of the first content than before receiving it.

In the embodiment, a driving evaluation system is exemplified as one of functions of an In-Vehicle Infotainment (IVI) system provided in a vehicle. The driving evaluation system includes an in-vehicle device mounted on a vehicle and a server device (referred to as an external device) capable of communicating with the in-vehicle device via a public communication network.

The in-vehicle device detects a behavior of a traveling vehicle based on, for example, information detected by a communication terminal (referred to as a first communication terminal) such as a smartphone used by a user riding on the vehicle. Furthermore, the in-vehicle device acquires, from the first communication terminal, the impression of the user on the driving action of the driver. The in-vehicle terminal evaluates the driver based on the behavior of the vehicle and the impression of the user.

The information evaluated by the in-vehicle device may be sent as driving information to an external device via a public communication network and managed by the external device. A driving evaluation system including such an in-vehicle device, a public communication network, and an external device will be described in more detail with reference to the drawings.

### Configuration Example of Driving Evaluation System

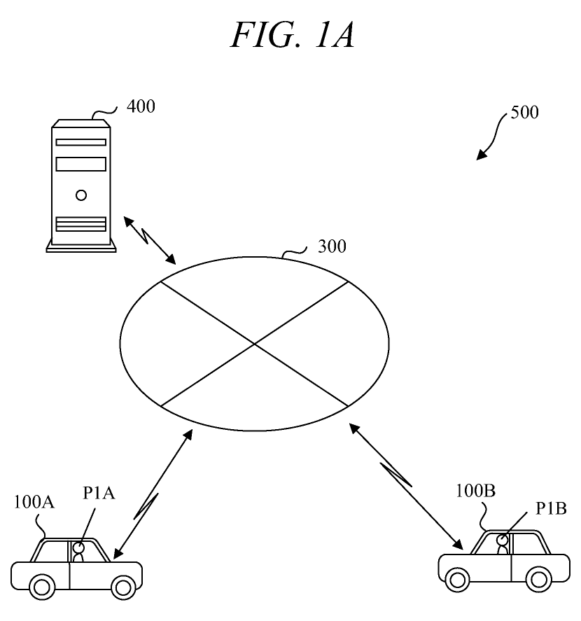

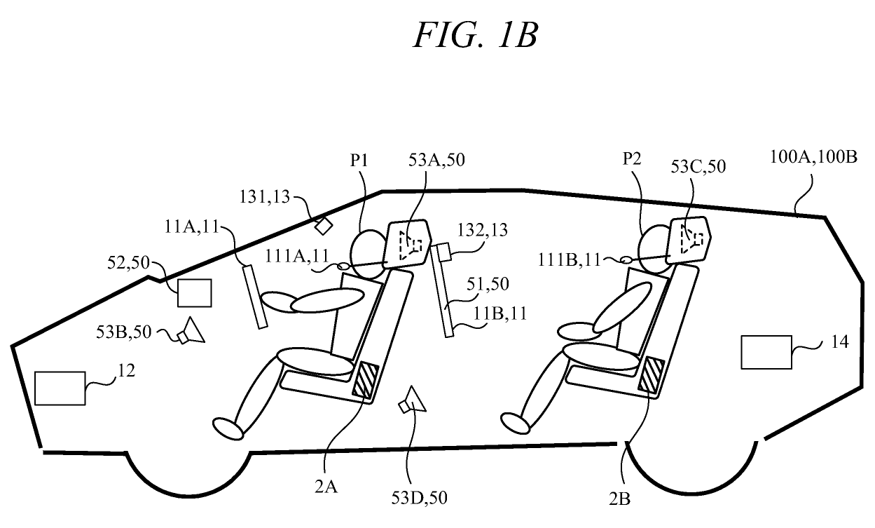

FIG. 1A is a schematic diagram illustrating an example of a driving evaluation system 500. In the embodiment, a system including a vehicle 100A driven by a driver P1A, a vehicle 100B driven by a driver P1B, a public communication network 300, and a server device 400 is exemplified as the driving evaluation system 500. In each of the vehicles 100A and 100B, driving of the driver P1A and the driver P1B is evaluated by each driving evaluation system.

### Configuration In Vehicle

FIG. 1B is a schematic diagram illustrating an example of the vehicle 100A equipped with an IVI system including a driving evaluation function as one of the functions. It is assumed that the vehicle 100A and the vehicle 100B have the same configuration. Therefore, in the following description, the vehicles 100A and 100B are referred to as a vehicle 100, the drivers P1A and P1B are referred to as a driver P1, and passengers P2A and P2B serving as users are referred to as a passenger P2.

The IVI system includes an in-vehicle device 14, a vehicle sensor group 12, a display unit 51, a projection unit 52, and voice reproduction units 53A to 53D constituting an output device 50, operation detection units 11A and 11B and microphones 111A and 111B constituting an input device 11, a front seat camera 131 and a rear seat camera 132 constituting a vehicle interior camera 13, a terminal 2A used by the driver P1 in a front seat of the vehicle interior, and a terminal 2B used by the passenger P2 in a rear seat of the vehicle interior. FIG. 1B illustrates a case where the driver P1 and the passenger P2 are seated in the vehicle interior.

The in-vehicle device 14 and the terminal 2A, and the in-vehicle device 14 and the terminal 2B are configured to be able to perform, for example, Ultra-Wide Band (UWB) wireless communication. The UWB wireless communication is a communication system that enables highly accurate positional measurement using an ultra-wide band frequency bandwidth. In the embodiment, the positions of the terminals 2A and 2B in the vehicle interior can be detected with high accuracy.

The in-vehicle device 14, the output device 50, the input device 11, the vehicle sensor group 12, and the vehicle interior camera 13 are configured to be able to perform wired communication by a Controller Area Network (CAN) or the like.

The terminals 2A and 2B are, by way of example, smartphones or the like used by each of the driver P1 and the passenger P2. The terminals 2A and 2B may be held by a holder (not illustrated) installed on a seat on which each person sits.

Although two terminals 2A and 2B are illustrated as terminals used by the driver P1 and the passenger P2, the actual number of terminals varies depending on the number of occupants, and may be four if there are four occupants. In addition, the number of cameras constituting the vehicle interior camera 13, the number of operation detection units and microphones constituting the input device 11, and the number of display units, projection units, and voice reproduction units constituting the output device 50 may also be appropriately changed according to the number of occupants.

In the IVI system, if a button corresponding to the driving evaluation is touch-operated from among a plurality of menu buttons (that may be referred to as icons) displayed on the output device 50, or if a voice corresponding to the driving evaluation is input from the microphones 111A and 111B constituting the input device 11 in a state where the output device 50 (projection unit 52, display unit 51) is caused to project or display an operation menu screen (not illustrated), the in-vehicle device 14 starts an operation as the driving evaluation unit 200 constituting the driving evaluation system 500.

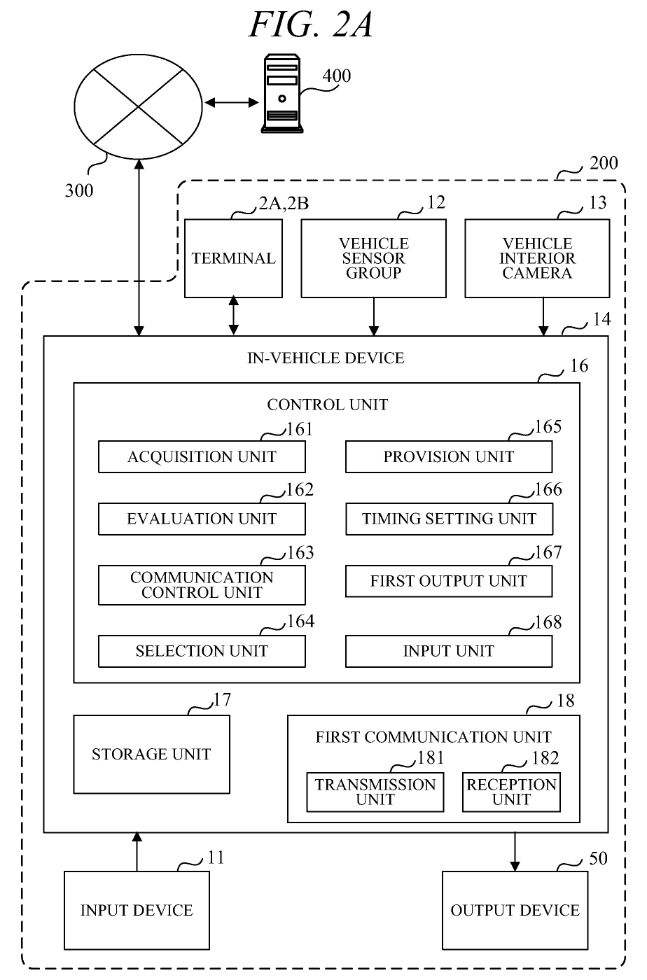

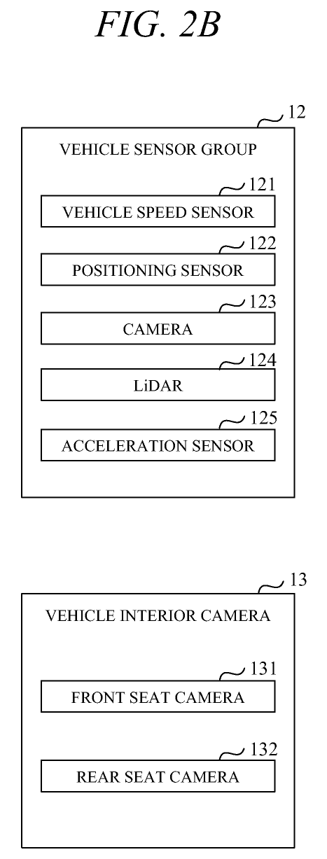

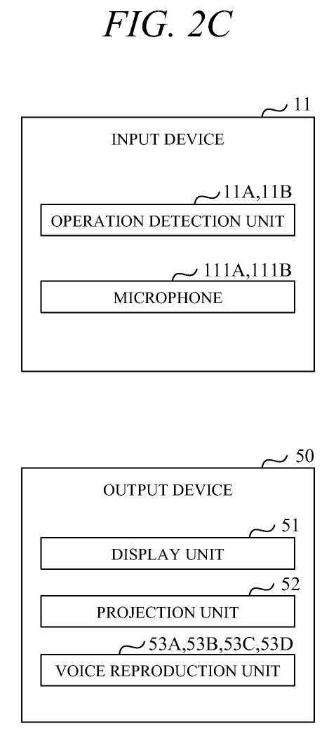

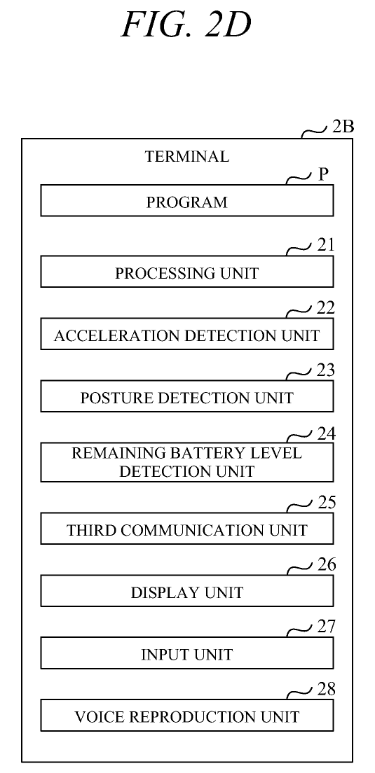

Hereinafter, the driving evaluation system 500 will be described focusing on the in-vehicle device 14. FIGS. 2A to 2D are diagrams describing a configuration example of each unit in FIG. 1B.

### In-vehicle Device

FIG. 2A is a block diagram illustrating a configuration of a main part of the in-vehicle device 14. The in-vehicle device 14 includes a control unit 16 that substantially functions as a Micro Processing Unit (MPU) of the IVI system, and reads and executes a predetermined program stored in a storage unit (not illustrated) in the control unit 16 to perform various information processing, control processing, and the like necessary in the in-vehicle device 14.

In FIG. 2A, the in-vehicle device 14 includes the control unit 16, an information storage unit 17, and a first communication unit 18. When starting the operation as the driving evaluation unit 200, the control unit 16 reads and executes an application program for the driving evaluation unit 200 stored in a storage unit in the control unit 16, thereby performing various types of information processing, control processing, and the like necessary for the driving evaluation unit 200.

The control unit 16 includes, as functional configurations for driving evaluation, an acquisition unit 161, an evaluation unit 162, a communication control unit 163, a selection unit 164, a provision unit 165, a timing setting unit 166, a first output unit 167, and an input unit 168.

### Acquisition Unit

The acquisition unit 161 acquires, from the terminal 2B via the first communication unit 18, acceleration data serving as behavior information indicating the behavior of the vehicle 100 detected by the terminal 2B, and acquires, from the terminal 2B via the first communication unit 18, angular velocity data serving as posture information indicating the posture of the terminal 2B fixed to the holder (not illustrated).

The acquisition unit 161 further acquires, from the terminal 2B via the first communication unit 18, information indicating an impression of the passenger P2 with respect to the driving action of driver P1. Specifically, the control unit 16 causes the transmission unit 181 to transmit, to the terminal 2B, question information asking the impression of the passenger P2 from among a plurality of pieces of question information prepared in advance. The question information includes, as an example, a signal for causing the terminal 2B to display a question of “How is the riding comfort?” and answer buttons of “good”, “normal”, and “bad”. In a case where the answer button ”bad” is operated at the terminal 2B, the question information further includes a signal for causing the terminal 2B to display answer buttons indicating whether the passenger P2 feels “bad” at the time of acceleration, at the time of deceleration, or at the time of turning.

### Evaluation Unit

The evaluation unit 162 generates a driving evaluation value based on the acceleration data and the angular velocity data acquired by the acquisition unit 161.

The evaluation unit 162 first scores the driving characteristics characterizing the way of driving of the driver P1 by using the acceleration data detected by the terminal 2B. This is based on the idea that the way of driving is characterized by the stability of acceleration, the stability of deceleration, the stability of turning, and the stability of straight advancement serving as driving characteristics.

In a case where the terminal 2B is being operated by the passenger P2, the terminal 2A of the driver P1 installed in the holder may preferentially detect the acceleration. Alternatively, among the acceleration data detected by the terminal 2B, the acceleration data detected during the operation (swing state by hand) may not be used for generating the driving evaluation value. As a result, since acceleration suitable for scoring the driving characteristics is adopted, the reliability of the evaluation function is improved.

In the embodiment, among the accelerations detected by the terminal 2A and the terminal 2B, the acceleration with respect to the advancing direction of the vehicle 100 is made to correspond to the acceleration and deceleration of the vehicle 100. In addition, among the accelerations detected by the terminal 2A and the terminal 2B, an acceleration in a direction orthogonal to the advancing direction of the vehicle 100 is made to correspond to turning.

The evaluation unit 162 scores each of the stability of acceleration, the stability of deceleration, the stability of turning, and the stability of straight advancement as follows based on the change in direction and magnitude of the acceleration acquired in time series while the vehicle 100is traveling.

### Stability of Acceleration

In the evaluation unit 162, for example, in a coordinate system of three axes (X-axis, Y-axis, Z-axis), an advancing direction of the vehicle 100is defined as an X-axis, a left-right direction orthogonal to the X-axis is defined as a Y-axis, and an up-down direction orthogonal to the X-axis and the Y-axis is defined as a Z-axis. Then, when the acceleration of the X-axis component detected by the terminal 2B (terminal 2A) is positive, it is treated as acceleration, and when the acceleration of the X-axis component detected by the terminal 2B (terminal 2A) is negative, it is treated as deceleration.

Therefore, in the case of evaluating the stability of the acceleration, the evaluation unit 162 evaluates the magnitude only if the acceleration of the X-axis component is positive. Then, the maximum value of the acceleration is counted for each acceleration operation, and as the ratio of the large acceleration exceeding a predetermined first threshold value in one traveling increases, the score for the stability of the acceleration in the traveling is decreased.

### Stability of Deceleration

In the case of evaluating the stability of the deceleration, the evaluation unit 162 evaluates the magnitude only if the acceleration of the X-axis component is negative. Then, the maximum value of the absolute value of the acceleration is counted for each deceleration operation, and as the ratio of the large acceleration at which the absolute value exceeds a predetermined second threshold value in one traveling increases, the score for the stability of the deceleration in the traveling is decreased.

### Stability of Turning

In the case of evaluating the stability of the turning, the evaluation unit 162 evaluates the magnitude regardless of whether the acceleration of the Y-axis component is positive or negative. Then, the maximum value of the absolute value of the acceleration is counted for each turning operation in which the sign of the acceleration of the Y-axis component is the same, and as the ratio of the large acceleration at which the absolute value exceeds a predetermined third threshold value in one traveling increases, the score for the stability of the turning in the traveling is decreased.

### Stability of Straight Advancement

In the case of evaluating the stability of the straight advancement, the evaluation unit 162 evaluates that there is no so-called abrupt steering. When abrupt steering operation is performed, the acceleration of the Y-axis component in the vehicle 100 increases, and thus it is common with a case of evaluating the stability of the turning in that the acceleration of the Y-axis component is the evaluation target. However, the maximum value of the absolute value of the acceleration of the Y-axis component is counted only under the condition that there is no acceleration/deceleration for a certain period of time, in other words, the magnitude of the absolute value of the acceleration of the X-axis component being within a predetermined value is continued for a certain period of time, and the maximum value is not counted at the time of a normal right/left turn (operation of turning right/left after decelerating). In the evaluation of the stability of the straight advancement, as the ratio of a large acceleration at which the absolute value exceeds a predetermined fourth threshold value in one traveling increases, the score for the stability of the straight advancement in the traveling is decreased.

### Correction to Acceleration Data

The evaluation unit 162 corrects the acceleration data based on the angular velocity data, and performs scoring of the driving characteristics as described above based on the corrected acceleration data. The reason for this is as follows.

In general, the coordinate system of the three axes (X-axis, Y-axis, Z-axis) related to the traveling of the vehicle 100 described above and the coordinate system of the three axes (x-axis, y-axis, z-axis) of the acceleration sensor in a case where the acceleration is detected by the terminal 2B (terminal 2A) fixed to the seat or the like (holder) of the vehicle 100 do not coincide with each other in many cases and there is a relative deviation due to the direction in which the terminal 2B (terminal 2A) is fixed.

Therefore, before scoring the driving characteristics, the evaluation unit 162 converts the acceleration data represented by three axes (x-axis, y-axis, z-axis) of the acceleration sensor of the terminal 2B (terminal 2A) into acceleration data represented by three axes (X-axis, Y-axis, Z-axis) related to traveling of the vehicle 100 by using the angular velocity data indicating the posture of the terminal 2B (terminal 2A). This conversion may be referred to as calibration. That is, in the embodiment, the corrected acceleration data is synonymous with the calibrated acceleration data.

Lastly, the evaluation unit 162 generates the driving evaluation value of the driver P1 based on the scores for the driving characteristic (stability of acceleration, stability of deceleration, stability of turning, and stability of straight advancement) detected by the terminal 2B (terminal 2A) of the passenger P2 of vehicle 100 and calculated based on the calibrated acceleration data.

The evaluation unit 162 adjusts the driving evaluation value based on the behavior of vehicle 100 described above based on the impression of the passenger P2. As an example, in a case where the impression of the passenger P2 is negative (e.g., in a case where the answer information corresponds to “bad”), the driving evaluation value is reduced. On the other hand, in a case where the impression of the passenger P2 is not negative (e.g., in a case where the answer information corresponds to “good” or “normal”), the generated driving evaluation value is adopted as it is.

Here, the acceleration data (behavior information of the vehicle 100) detected and calibrated by the terminal 2B (terminal 2A) is compared with answer information of the passenger P2 to the question (may be referred to as comparison), and an incorrect answer of the passenger P2 is determined. In a case where it is determined that the answer is an incorrect answer, the driving evaluation value may not be decreased.

In this manner, the evaluation unit 162 evaluates the driver P1 based on the behavior of vehicle 100 and the impression of the passenger P2.

Note that, in the embodiment, as an example, when the driver P1 and the passenger P2 get on the vehicle 100, the in-vehicle device 14 may speak to the driver P1 and the passenger P2 via the voice reproduction units 53A to 53D constituting the output device 50, the microphones 111A and 111B constituting the input device 11 may collect voices (e.g., introducing one's own name) responded by the driver P1 and the passenger P2, and the front seat camera 131 and the rear seat camera 132 constituting the vehicle interior camera 13 may photograph the driver P1 and the passenger P2.

The in-vehicle device 14 associates (may be said to relate) the faces of the driver P1 and the passenger P2, the names of the driver P1 and the passenger P2, and the frequency components of the voice uttered by the driver P1 and the passenger P2, so that it is possible to identify the faces, the names, and the voices of all the occupants in the vehicle interior.

The in-vehicle device 14 manages the information regarding the driving action acquired as the driving evaluation unit 200 as driving information of the driver P1 seated on the driver's seat.

### Communication Control Unit

The communication control unit 163 causes the transmission unit 181 of the first communication unit 18 to transmit, to the terminal 2B, question information inquiring about the impression of the passenger P2 with respect to the driving action of the driver P1, and causes the reception unit 182 of the first communication unit 18 to receive, from the terminal 2B, behavior information indicating the behavior of the vehicle 100 and answer information input by the passenger P2 with respect to the question information.

### Selection Unit

The selection unit 164 selects the first content from among a plurality of pieces of content prepared in advance in the information storage unit 17 based on a result of the evaluation by the evaluation unit 162 (e.g., the driving evaluation value). As described above, the first content is content for conveying (learning) advice for improving the driving action. As an example, the selection unit 164 selects, as the first content, learning content related to an item having a relatively low score among the stability of acceleration, the stability of deceleration, the stability of turning, and the stability of straight advancement.

The selection unit 164 further selects the second content from among the plurality of pieces of content prepared in advance in the information storage unit 17 according to the driving actions of the driver P1 before and after receiving the provision of the first content. As described above, the second content is content for notifying the driver P1 that the driving action has improved. However, in a case where the driving action is not improved, content notifying that the driving action has not improved may be selected.

### Provision Unit

The provision unit 165 provides the content selected by the selection unit 164 to the driver P1. The content provided to the driver P1 can be viewed by the driver P1 in the vehicle interior. When the first content is selected by the selection unit 164, the provision unit 165 provides the first content to the driver P1. Furthermore, when the second content is selected by the selection unit 164, the provision unit 165 provides the second content to the driver P1.

Note that the provided content may be video content (moving image, still image, text display, icon display, graphic display, etc.) or sound content. The sound content includes voice content and music content.

### Timing Setting Unit

The timing setting unit 166 sets a first timing at which the communication control unit 163 causes the transmission unit 181 to transmit question information inquiring about the impression of the passenger P2 necessary for the evaluation unit 162 to evaluate the driving action of the driver P1. In a case where the evaluation unit 162 performs evaluation a plurality of times during one ride in which the driver P1 rides the vehicle 100 with the passenger P2, the first timing is set a plurality of times in correspondence with the timing at which the evaluation is performed a plurality of times. Here, the number of evaluations by the evaluation unit 162 is set to one, for example, in a case where the distance from the departure place to the destination of the vehicle 100 on which the driver P1 travels with the passenger P2 is equal to or less than a predetermined distance, or the scheduled required time required for the movement from the departure place to the destination is within a predetermined time. In other words, in a case where the predetermined distance is exceeded and the scheduled required time exceeds the predetermined time, the number of times is plurals.

Furthermore, the timing setting unit 166 sets the second timing at which the communication control unit 163 causes the transmission unit 181 to transmit the first content or the second content selected by the selection unit 164 and provided by the provision unit 165 in accordance with the result of the evaluation by the evaluation unit 162 (e.g., the driving evaluation value). In a case where the evaluation unit 162 performs evaluation a plurality of times during one ride in which the driver P1 rides the vehicle 100 with the passenger P2, the second timing is set a plurality of times in correspondence with the timing at which the evaluation is performed a plurality of times. In other words, in a case where the number of evaluations during one ride is one, the timing setting unit 166 limits each of the first timing and the second timing to one.

### First Output Unit

The first output unit 167 outputs a video signal to the output device 50 in a case of reproducing video content serving as first content or second content according to an instruction from the driver P1. As a result, the video based on the video signal output from the first output unit 167 is displayed on the display unit constituting the output device 50.

The first output unit 167 outputs a reproduction signal to the output device 50 in a case of reproducing voice content serving as first content or second content according to an instruction from the driver P1. As a result, the voice based on the reproduction signal output from the first output unit 167 is reproduced by the speaker or the like constituting the output device 50.

### Input Unit

The input unit 168 inputs voices uttered by the driver P1 and the passenger P2. More specifically, the voice signal of the driver P1 collected by the microphone 111A is input. Furthermore, the voice signal of the passenger P2 collected by the microphone 111B is input.

### Information Storage Unit

The information storage unit 17 stores question information for the passenger P2. In addition to the question regarding riding comfort described above, a plurality of questions such as if one feels fear, feels discomfort, and how one feels are stored.

As an example, the control unit 16 may select the question information from among the question information stored in the information storage unit 17 based on the magnitude of the acceleration acquired in time series while the vehicle 100 is traveling. In a case where the magnitude of the acceleration exceeds a predetermined value, whether one feels fear, discomfort, or the like may be selected, and in a case where the magnitude of the acceleration does not exceed the predetermined value, how the riding comfort is, how one feels, whether one feels safe, or the like may be selected.

In addition, the information storage unit 17 stores content information (including a plurality of pieces of first content and a plurality of pieces of second content) to be provided to the driver P1.

The selection unit 164 normally selects content to be provided to the driver P1 from among the content stored in the information storage unit 17. However, for example, in order to enrich the types of content, not only content stored in the information storage unit 17 but also content acquired from an external device such as the server device 400 via the public communication network 300 may be selected.

The second content may include a message. For example, in a case where the result of the evaluation by the evaluation unit 162 is higher than a predetermined reference value, or in a case where the result of the evaluation after receiving the provision of the first content improved than before receiving the provision, a message praising the driver P1 is stored in the information storage unit 17 as a first message. Furthermore, in a case where the result of the evaluation by the evaluation unit 162 is lower than the reference value, or in a case where the result of the evaluation after receiving the provision of the first content is worse than that before receiving the provision, a message encouraging improvement of the driving action of the driver P1 is stored in the information storage unit 17 as a second message. The message is selected by the selection unit 164.

Furthermore, the information storage unit 17 stores incentive information to be provided to the passenger P2.

The incentive information has a meaning of gratitude from a business operator or the like to which the driver P1 belongs (may be a contract) to the passenger P2 who has answered the question, and a plurality of types of incentive information are prepared. For example, the information may be information indicating the number of points available in another service developed by a business operator or the like who manages or operates an external device (an information processing device to be described later), message information of gratitude, or short message information such as “Thank you”.

Furthermore, the incentive information may be made different according to the degree of improvement of the evaluation result of the driver P1, and for example, may be divided into three stages of A, B, and C. For example, the control unit 16 may be configured to automatically select incentive information of different ranks according to the degree of improvement of the evaluation result of the driver P1. The incentive information selected by the control unit 16 is transmitted to the terminal 2B of the passenger P2 by the transmission unit 181.

### First Communication Unit

The first communication unit 18 includes a short-range wireless communication module (not illustrated) that performs wireless communication with the terminals 2A and 2B and a wired communication module (not illustrated) that performs wired communication by CAN or the like. The UWB wireless communication system described above may be adopted for the short-range wireless communication module.

The first communication unit 18 includes a transmission unit 181 and a reception unit 182.

FIG. 2B is a block diagram illustrating a configuration of a main part of the vehicle sensor group 12 and the vehicle interior camera 13 of the vehicle 100.

### Vehicle Sensor Group

The vehicle sensor group 12 includes a vehicle speed sensor 121, a positioning sensor 122, a camera 123, a LiDAR 124, and an acceleration sensor 125. An operation detection sensor (not illustrated) for detecting operations on various driving operators may also be included in the vehicle sensor group 12.

### Vehicle Speed Sensor

The vehicle speed sensor 121 detects a vehicle speed of the vehicle 100 and outputs vehicle speed information to the in-vehicle device 14.

### Positioning Sensor

The positioning sensor 122 detects the current position of the vehicle 100 based on positioning signals from Global Positioning System (GPS) satellites, quasi-zenith satellites, or the like. The positioning sensor 122 outputs a signal indicating the current position to the in-vehicle device 14 as position information.

### Camera

The camera 123 photographs the surroundings of the vehicle 100. The camera 123 outputs data of a subject image to the in-vehicle device 14 as image information. The camera 123 can capture a still image or a moving image.

### LiDAR

The Light Detection And Ranging (LiDAR) 124 performs scanning by changing an irradiation angle of laser light to be emitted, and measures detection of an object, a distance to the object, and the like based on the position information of each detection point. The measurement data is output to the in-vehicle device 14.

### Acceleration Sensor

The acceleration sensor 125 detects an acceleration of the vehicle 100 and outputs acceleration information to the in-vehicle device 14.

### Vehicle Interior Camera

The vehicle interior camera 13 includes the front seat camera 131 and the rear seat camera 132. The front seat camera 131 photographs the upper body of the driver P1 sitting in the front seat, and outputs data of the subject image to the in-vehicle device 14 as image information. The rear seat camera 132 photographs the upper body of the passenger P2 sitting in the rear seat, and outputs data of the subject image to the in-vehicle device 14 as image information.

FIG. 2C is a block diagram illustrating a configuration of a main part of the input device 11 and the output device 50 of the in-vehicle device 14 of the vehicle 100.

### Input Device

The input device 11 includes operation detection units 11A and 11B and microphones 111A and 111B.

### Operation Detection Unit

The operation detection unit 11A is operated by the driver P1 in the front seat, and outputs an operation signal to the in-vehicle device 14. The operation detection unit 11A may be configured as a pointing device that interlocks with a projection image projected by the projection unit 52 described later. The operation detection unit 11B is provided on the display surface of the display unit 51. The operation detection unit 11B is operated by the passenger P2 in the rear seat and outputs an operation signal indicating a touch position to the in-vehicle device 14.

### Microphone

The microphone 111A collects voice uttered by the driver P1 in the front seat and outputs a voice signal to the in-vehicle device 14. The microphone 111B collects voice uttered by the passenger P2 in the rear seat and outputs a voice signal to the in-vehicle device 14.

### Output Device

The output device 50 includes the display unit 51, the projection unit 52, and the voice reproduction unit 53. The output device 50 is used, for example, for displaying an operation menu screen, reproducing contents, or the like.

### Display Unit

The display unit 51 has a screen such as a liquid crystal display, and displays image information based on a display signal output from the in-vehicle device 14. The image information includes the operation menu screen, an image of video content, and the like.

### Projection Unit

The projection unit 52 includes, for example, a head-up display (HUD) to be projected on a windshield or the like, and projects image information based on a projection signal output from the in-vehicle device 14. The image information includes the operation menu screen, an image of video content, and the like.

### Voice Reproduction Unit

The voice reproduction units 53A to 53D are configured as speakers for reproducing and outputting voice and the like, and reproduce sound content and the like based on a reproduction signal output from the in-vehicle device 14. Note that a voice output unit that outputs a content reproduction signal to a headphone (not illustrated) or the like may be provided.

### Terminal

FIG. 2D is a block diagram illustrating a configuration of a main part of the terminal 2B. Since the configuration of the terminal 2A is similar to that of the terminal 2B, illustration thereof will be omitted. The terminal 2B includes a processing unit 21 such as an MPU, and reads and executes a predetermined program P (which may also be referred to as an application) stored in a storage unit (not illustrated) to perform various types of information processing, control processing, and the like necessary for the functional configurations described below.

The terminal 2B includes, as functional configurations, an acceleration detection unit 22, a posture detection unit 23, a remaining battery level detection unit 24, a third communication unit 25, a display unit 26, an input unit 27, and a voice reproduction unit 28.

Note that the smartphone generally includes the display unit 26, the input unit 27, the voice reproduction unit 28, and the like, but the description thereof will be omitted.

Furthermore, for example, the terminal 2B may share a function in combination with another device such as a smart watch.

### Acceleration Detection Unit

The acceleration detection unit 22 detects accelerations in three axes (corresponding to x-axis, y-axis, and z-axis), and sends each of the detection signals as a set of acceleration data to the in-vehicle device 14 via the third communication unit 25.

### Posture Detection Unit

The posture detection unit 23 includes, for example, a gyro sensor. The posture detection unit 23 detects each angular velocity of rotation in the three axes (corresponding to x-axis, y-axis, and z-axis), and sends each of the detection signals as a set of angular velocity data to the in-vehicle device 14 via the third communication unit 25. Since the posture of the terminal 2B can be calculated using the angular velocity data, the angular velocity data may be referred to as posture information. The posture information is information essential for calibration of the acceleration data.

### Remaining Battery Level Detection Unit

The remaining battery level detection unit 24 detects the remaining level of a battery (not shown) that supplies power consumed by the terminal 2B, and sends a detection signal to the in-vehicle device 14 via the third communication unit 25.

### Third Communication Unit

The third communication unit 25 includes a UWB wireless communication module (not illustrated) that performs wireless communication with the in-vehicle device 14.

### Description of Flowchart

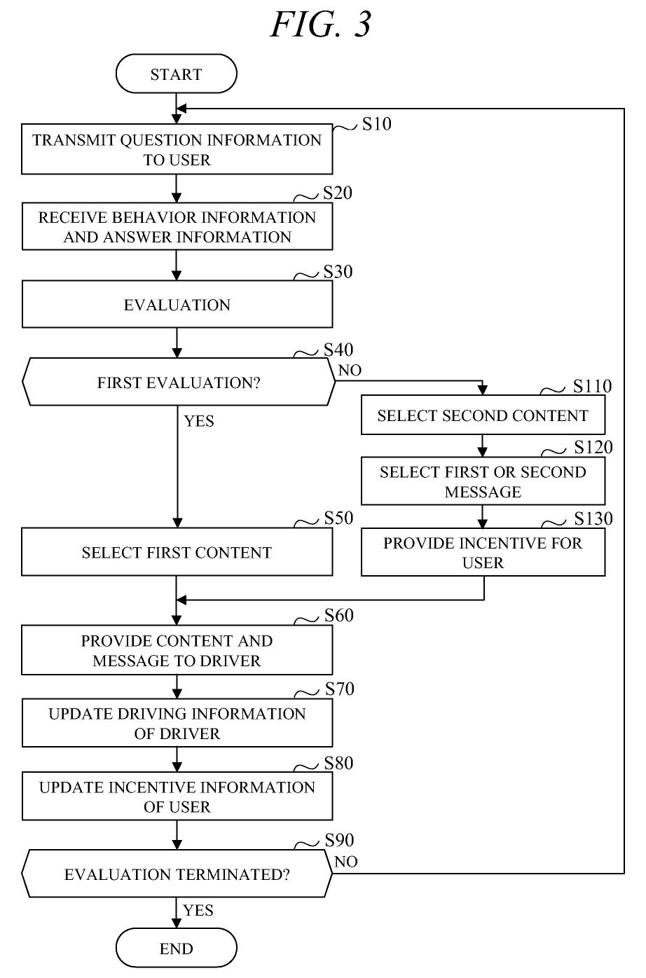

FIG. 3 is a flowchart for describing an example of a driving evaluation processing by a program executed by the MPU (control unit 16) of the in-vehicle device 14. For example, when the “driving evaluation” button is operated on the operation menu screen (not illustrated), the control unit 16 of the in-vehicle device 14 executes a program for causing the IVI system to function as the driving evaluation unit 200.

In step S10 (S: processing step) in FIG. 3, the control unit 16 causes the transmission unit 181 to transmit the question information to the user (more specifically, the terminal 2B of the passenger P2 serving as the user), and proceeds to step S20.

In S20, the control unit 16 causes the reception unit 182 to receive the behavior information indicating the behavior of the vehicle 100 and the answer information that the passenger P2 has input to the terminal 2B in response to the question information, and proceeds to S30.

In S30, the control unit 16 causes evaluation unit 162 to perform evaluation related to the driving action of driver P1 of vehicle 100, and proceeds to S40.

In S40, the control unit 16 determines whether or not the evaluation is the first evaluation during one ride traveling from the departure place to the destination. The control unit 16 makes an affirmative determination in S40 in the case of the first time and proceeds to S50, and makes a negative determination in S40 in the case of the second and subsequent times and proceeds to S110.

In S50, the control unit 16 causes the selection unit 164 to select the first content according to the result of the evaluation by the evaluation unit 162 from among the plurality of pieces of first content stored in the information storage unit 17, and proceeds to S60.

In S60, the control unit 16 causes the provision unit 165 to provide the content (the first content or the second content) and the message (if the first message or the second message is included) to the driver P1, and proceeds to S70. In the embodiment, having the content and the message in a state viewable by the driver P1 (in other words, a state that can be output from the first output unit 167) is referred to as provision.

In S70, the control unit 16 updates the driving information of the driver P1, and proceeds to S80. For example, the control unit 16 records, as the driving information, when and where the driver P1 of vehicle 100 traveled, what kind of driving action the driver took, what was the driving evaluation value, whether the driving evaluation value improved after the first content is provided, and the like in a storage unit (not illustrated) in the control unit 16 for each driver. In S70, updating and recording of adding the latest driving information to such driving information for each driver are performed.

In S80, the control unit 16 updates the incentive information of the user (passenger P2), and proceeds to S90. The control unit 16 records, for example, incentive information indicating when and what kind of incentive the user has been provided in a storage unit (not illustrated) in the control unit 16 for each user.

In S90, the control unit 16 determines whether or not the evaluation is terminated. In a case where a predetermined terminating operation is performed, the control unit 16 makes an affirmative determination in S90 and terminates the processing according to FIG. 3. In a case where the terminating operation is not performed, the control unit 16 makes a negative determination in S90 and returns to S10. In the case of returning to S10, the control unit 16 repeats the above-described processing.

In step S110 to which the processing proceeds if negative determination is made in step S40 described above, the control unit 16 causes the selection unit 164 to select the second content according to the result of the evaluation by the evaluation unit 162 from among a plurality of pieces of second content stored in the information storage unit 17, and proceeds to step S120.

In S120, the control unit 16 causes the selection unit 164 to select the first or second message according to the result of the evaluation by the evaluation unit 162 from among a plurality of messages stored in the information storage unit 17, and proceeds to S130.

In S130, the control unit 16 provides an incentive for the user (passenger P2), and proceeds to S60. In the embodiment, transmission of the incentive information selected by the control unit 16 to the terminal 2B of the passenger P2 by the transmission unit 181 is referred to as provision.

According to the embodiment described above, the following effects are obtained.

(1) A driving evaluation system 500 that evaluates a driver P1 of a vehicle 100 traveling with a passenger P2 serving as a user based on information related to a driving action of the driver P1, and includes a first communication unit 18 that performs communication with a terminal 2B, serving as a first communication terminal, having a function of detecting a behavior of the vehicle 100, and used by the passenger P2, a communication control unit 163 that causes the first communication unit 18 to transmit, to the terminal 2B, question information asking an impression of the passenger P2 with respect to the driving action and receive, from the terminal 2B, behavior information indicating the behavior and answer information input by the passenger P2 with respect to the question information, an evaluation unit 162 that performs evaluation on the driver P1 based on the behavior information and the answer information, a selection unit 164 that selects a first content based on a result of the evaluation by the evaluation unit 162 and selects second content according to the driving actions of the driver P1 before and after receiving provision of the first content, and a provision unit 165 that provides the first content if the first content is selected by the selection unit 164 and the second content if the second content is selected by the selection unit 164 to the driver.

With this configuration, it is possible to make the driver P1 himself/herself be aware of the driving action of the driver P1 that cannot be obtained only from the behavior of the vehicle 100 for example, by objective evaluation based on the behavior of the vehicle 100 detected by the terminal 2B of the passenger P2 who is an occupant of a taxi or ride-share and the impression of the passenger P2. For example, in the case of unpreferable driving that makes the passenger P2 feel anxious, it is expected to improve the way of driving, and in the case of preferable driving that gives the passenger P2 a sense of security, it is expected to improve motivation of the driver P1 on driving who tries to drive more safely. As a result, the driver P1 continuously uses the driving evaluation system 500, and it is expected that it will lead to motivation to improving acceptability to the driving evaluation system 500.

(2) In the driving evaluation system 500 of (1), the first communication unit 18 further communicates with the terminal 2A serving as the second communication terminal used by the driver P1, the communication control unit 163 further causes the first communication unit 18 to transmit the first content or the second content provided from the provision unit 165 to the terminal 2A, and the evaluation unit 162 performs evaluation a plurality of times based on a distance from a departure place to a destination of the vehicle 100 or a scheduled required time.

With this configuration, it is possible to perform the evaluation a plurality of times according to the distance from the departure place to the destination of the vehicle 100 or the scheduled required time, and to transmit the content reflecting the objective evaluation by the passenger P2 to the terminal 2A of the driver P1 at the time of each evaluation.

(3) In the driving evaluation system 500 of (2), the provision unit 165 further provides a first message praising the driver P1 in a case where the result of the evaluation by the evaluation unit 162 is higher than a reference value defined in advance or in a case where the result of the evaluation after receiving the provision of the first content improved than before receiving the provision of the first content, and provides a second message encouraging the driver P1 to improve the driving action in a case where the result of the evaluation is lower than the reference value or in a case where the result of the evaluation after receiving the provision of the first content is worse than before receiving the provision of the first content, and the communication control unit 163 further causes the first communication unit 18 to transmit the first message or the second message to the terminal 2A.

For example, follow-up reflecting the objective evaluation becomes possible by sending a message corresponding to the objective evaluation to the driver P1 at the time of each evaluation.

(4) In the driving evaluation system 500 of (2), in a case where the result of the evaluation by the evaluation unit 162 improved after receiving the provision of the first content, the provision unit 165 further provides an incentive to the passenger P2 who has input the answer information used by the selection unit 164 at the time of selecting the first content to the terminal 2B, and the communication control unit 163 further causes the first communication unit 18 to transmit information indicating the incentive to the terminal 2B.

With such a configuration, if the driving action of the driver P1 is improved, it is expected that the passenger P2 will be motivated to continue to use the service (taxi, bus, ride sharing, etc.) and to input an answer to the question information by giving an incentive to the passenger P2.

Note that the incentive to the passenger P2 does not necessarily need to be a financial incentive such as a coupon or a usage fee discount, and may be approval, gratitude, or the like.

As the driver P1, a business operator who operates the system, and the like, as well as the passenger P2 serving as a user cooperate with each other, high-quality driving education with respect to the driver P1 can be achieved, and it is also expected that the passenger P2 will continuously use the service, leading to securing profitability of the business operator and the like.

(5) The driving evaluation system 500 of (2) further includes a timing setting unit 166 that sets a first timing at which the communication control unit 163 causes the first communication unit 18 to transmit the question information and a second timing at which the communication control unit 163 causes the first communication unit 18 to transmit the first content or the second content a plurality of times in correspondence with the timings of the plurality of evaluations by the evaluation unit 162.

With this configuration, in a case where the distance from the departure place to the destination of the vehicle 100 is long or in a case where the scheduled required time to the destination is long, it is possible to increase the frequency of providing the first content such as advice to the driver P1.

(6) In the driving evaluation system 500 of (5), the evaluation unit 162 sets the number of evaluations to one if the distance from the departure place to the destination is equal to or less than a predetermined distance or the scheduled required time is within a predetermined time, and the timing setting unit 166 limits each of the first timing and the second timing to one in a case where the number of evaluations is one.

Contrary to the case (5), if the distance from the departure place to the destination of the vehicle 100 is short, or if the scheduled required time to the destination is short, the number of times of providing the first content such as advice to the driver P1 is limited, so that the burden on the passenger P2 to answer the question can be reduced, and the reasonable operation of the driving evaluation system 500 becomes possible.

(7) In the driving evaluation system 500 of (1), the evaluation unit 162 performs evaluation on the driver P1 based on the comparison result between the behavior of the vehicle 100 and the answer information of the passenger P2 to the question.

With this configuration, it is possible to compare the behavior of the vehicle 100 detected using the sensor built in the terminal 2B of the passenger P2 with the answer of the passenger P2 to the question, and for example, it is possible to improve the accuracy of the evaluation by, for example, excluding an incorrect answer or a malicious answer of the passenger P2.

The above-described embodiments may be modified into various modes. Hereinafter, modified examples will be described.

### First Modified Example

In the above-described embodiment, an example has been described in which the driving evaluation unit 200 for each vehicle 100 performs evaluation on the driving of the driver P1 and provision of the first and second contents to the driver P1, but the server device 400 serving as the external device of FIG. 1A connected to the vehicle 100 via the public communication network 300 may bear a part of the driving evaluation processing performed for each vehicle 100. At that time, the terminal 2A used by the driver P1 and the terminal 2B used by the passenger P2 communicate with each other via wireless communication such as a public communication network using a mobile line, Wi-Fi (registered trademark), Bluetooth (registered trademark), or UWB, and the driving evaluation processing is performed. This may be performed via a server device, or data may be directly exchanged between the terminals 2A and 2B.

As a result, since the evaluation processing can be performed by the server device 400 without depending on the in-vehicle device 14, it is not necessary to install an expensive device for each vehicle, and the cost can be reduced. In addition, since it is possible to collect and analyze driving evaluation data at an early stage by using wireless communication, it is also possible to improve the real-time property with respect to the driving evaluation and to achieve integrated management of the data.

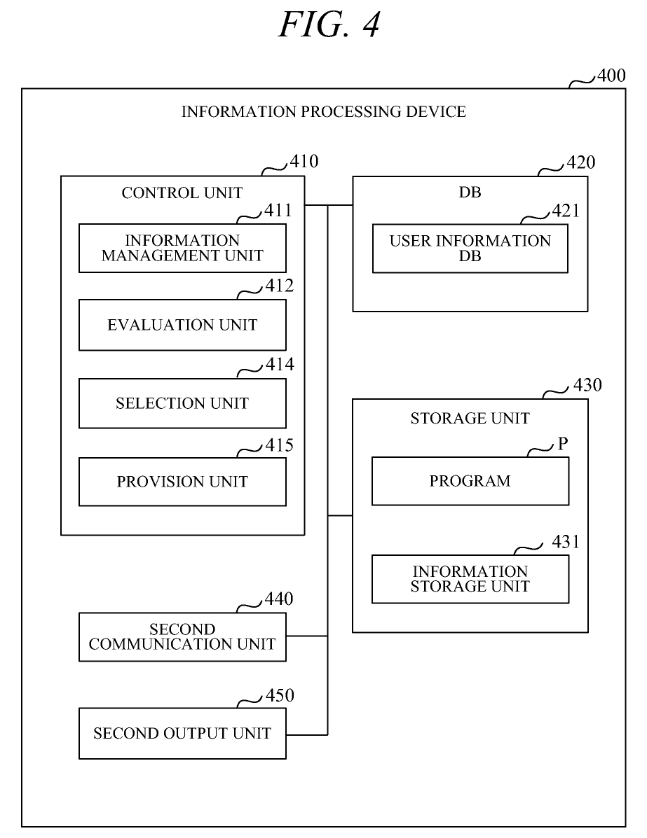

FIG. 4 is a block diagram illustrating a configuration of a main part of the information processing device (server device 400) according to a first modified example.

The server device 400 includes a control unit 410, database (hereinafter referred to as DB) 420, storage unit 430, and second communication unit 440. The control unit 410 includes an arithmetic processing unit such as a Central Processing Unit (CPU) or a Micro Processing Unit (MPU), and performs various types of information processing, control processing, and the like necessary for the server device 400 by reading and executing the program P stored in the storage unit 430.

The control unit 410 includes, as functional configurations for driving evaluation, an information management unit 411, an evaluation unit 412, a selection unit 414, and a provision unit 415.

The information management unit 411 manages the driving information and the driver P1 to be evaluated in association with each other, and manages the incentive information from the business operator or the like and the passenger P2 (user) who is given the incentive information in association with each other.

The evaluation unit 412 performs processing similar to that of the evaluation unit 162 of the in-vehicle device 14 described above on the driving action of the driver P1 of each vehicle 100 based on the information regarding the driving action acquired by the acquisition unit 161 of each vehicle 100 input via the second communication unit 440 described later and the answer information input by the passenger P2 to the question information in each vehicle 100.

The selection unit 414 performs processing similar to that of the selection unit 164 of the in-vehicle device 14 described above with reference to the information storage unit 431 described later based on the result of the evaluation result (e.g., the driving evaluation value) by the evaluation unit 412.

The provision unit 415 performs processing similar to that of the provision unit 165 of the in-vehicle device 14 described above by providing the content selected by the selection unit 414 to the driver P1 of the related vehicle 100 via the second communication unit 440 to be described later.

The DB 420 is a large-capacity storage device including, for example, a hard disk or the like. The DB 420 includes a user information DB 421. The user information DB 421 stores predetermined registration information regarding a user (the passenger P2 riding on each vehicle 100) registered in advance.

In the embodiment, the storage unit 430 and the DB 420 may be configured as an integrated storage device. Furthermore, the DB 420 may include a plurality of storage devices. Furthermore, the DB 420 may be an external storage device connected to the server device 400.

The storage unit 430 includes a storage element such as a Random Access Memory (RAM) or a Read Only Memory (ROM), and stores a program P, data, or the like necessary for the control unit 410 to execute processing. In addition, the storage unit 430 temporarily stores data and the like necessary for the control unit 410 to execute arithmetic processing. The storage unit 430 further stores a driving evaluation program (Application Program; hereinafter simply referred to as an application) to be provided to the in-vehicle device 14 of the vehicle 100 for which the application is desired to be provided.

Furthermore, the content information, the message information, and the incentive information stored in the information storage unit 17 of each vehicle 100 may be stored in the information storage unit 431. In a case where the content information, the message information, and the incentive information stored in the information storage unit 431 are revised, the content information, the message information, and the incentive information may be distributed to the in-vehicle device 14 of each vehicle 100 via the second communication unit 440 described later.

The second communication unit 440 includes a processing circuit or the like for performing processing related to communication, and transmits and receives information to and from an external device such as the in-vehicle device 14 via the public communication network 300.

The second output unit 450 includes a display unit and a voice reproduction unit, and for example, outputs necessary information to the operator of the server device 400 by displaying and reproducing.

According to the driving evaluation system 500, the following operational effects can be obtained. That is, in the driving evaluation system 500 of (3) described above according to the embodiment, the in-vehicle device 14 mounted on the vehicle 100 and including the first communication unit 18, the communication control unit 163, and the first output unit 167 that outputs information, and the server device 400 serving as an external device including the second communication unit 440 that performs communication with the first communication unit 18 of the in-vehicle device 14, the evaluation unit 412, the selection unit 414, the provision unit 415, and the second output unit 450 that outputs information are provided, and the first content, the second content, the first message, and the second message are output by at least one of the terminal 2A serving as the second communication terminal, the first output unit 167, and the second output unit 450.

With such a configuration, it is possible to simplify the in-vehicle device 14 of each vehicle 100 by placing a part of the configuration of the in-vehicle device 14 of FIG. 1B on the server device 400 that is an external device when viewed from each vehicle 100 and distributing the processing.

Furthermore, it is possible to improve software maintainability such as update and improvement of the driving evaluation program.

The server device 400 may be applied to an edge computer having high real-time property and data governance property in addition to a cloud type that simply performs data distribution.

Furthermore, by enabling communication access from a business operator or the like, to which the driver P1 belongs or has a contract with, to the server device 400, the business operator or the like can grasp the evaluation result and it can be caused to function as a safe driving management system by the business operator or the like. In particular, it is useful for the education of the driver P1.

### Second Modified Example

In a second modified example, the control unit 16 of the in-vehicle device 14 may detect whether or not the terminal 2B of the passenger P2 is in an unsuitable situation not suitable for acquiring the acceleration data indicating the behavior of the vehicle 100.

The unsuitable situation may include, for example, a case where a predetermined application for detecting the behavior of the vehicle 100 is not activated at the terminal 2B, a case where the behavior information of the vehicle 100 cannot be obtained because wireless communication cannot be performed between the first communication unit 18 of the in-vehicle device 14 and the terminal 2B, a case where the remaining battery level of the terminal 2B is lower than a predetermined value, a case where angular velocity data serving as posture information acquired by the terminal 2B indicates that the terminal 2B is not fixed to the holder (not illustrated) (reliability of the behavior information is insufficient), or the like.

In a case where the unsuitable situation is detected, the reliability of the behavior information is assumed to be lower than the predetermined value, and thus the control unit 16 cancels the evaluation on the driving action of the driver P1 by evaluation unit 162.

According to the second modified example, in a case where there is a possibility that information cannot be stably obtained from the terminal 2B, it is possible to secure reliability of the evaluation function by canceling the evaluation by the evaluation unit 162.

The above embodiment can be combined as desired with one or more of the aforesaid modifications. The modifications can also be combined with one another.

According to the present invention, it becomes possible to encourage the driver to improve the driving action that affects, for example, the riding comfort.

Above, while the present invention has been described with reference to the preferred embodiments thereof, it will be understood, by those skilled in the art, that various changes and modifications may be made thereto without departing from the scope of the appended claims.

1. A driving evaluation system configured to evaluate a driver of a vehicle traveling with a user based on information related to a driving action of the driver, comprising:
an in-vehicle device provided in the vehicle and including a processor and a memory coupled to the processor; and
a first communication terminal configured to detect a behavior of the vehicle and used by the user, wherein
the in-vehicle device is configured to perform:
performing communication with the first communication terminal;
through the communication, transmitting, to the first communication terminal, question information asking an impression of the user with respect to the driving action and receiving, from the first communication terminal, behavior information indicating the behavior and answer information input by the user with respect to the question information;
performing evaluation on the driver based on the behavior information and the answer information;
selecting first content based on a result of the evaluation and selecting second content according to the driving actions of the driver before and after receiving provision of the first content; and
providing the first content if the first content is selected and the second content if the second content is selected to the driver.

2. The driving evaluation system according to claim 1, wherein
the in-vehicle device is further configured to perform:
performing communication with a second communication terminal used by the driver;
through the communication, transmitting the first content or the second content to the second communication terminal; and
performing the evaluation a plurality of times based on a distance from a departure place to a destination of the vehicle or a scheduled required time.

3. The driving evaluation system according to claim 2, wherein
the in-vehicle device is further configured to perform:
providing a first message praising the driver in a case where the result of the evaluation is higher than a reference value defined in advance or in a case where the result of the evaluation after receiving the provision of the first content improved than before receiving the provision of the first content;
providing a second message encouraging the driver to improve the driving action in a case where the result of the evaluation is lower than the reference value or in a case where the result of the evaluation after receiving the provision of the first content is worse than before receiving the provision of the first content; and
through the communication, transmitting the first message or the second message to the second communication terminal.

4. A driving evaluation system configured to evaluate a driver of a vehicle traveling with a user based on information related to a driving action of the driver, comprising:
an in-vehicle device provided in the vehicle and including a first processor and a first memory coupled to the first processor;
a server device including a second processor and a second memory coupled to the second processor;
a first communication terminal configured to detect a behavior of the vehicle and used by the user; and
a second communication terminal used by the driver, wherein
the in-vehicle device is configured to perform:
performing communication with the first communication terminal and the second communication terminal; and
through the communication, transmitting, to the first communication terminal, question information asking an impression of the user with respect to the driving action and receiving, from the first communication terminal, behavior information indicating the behavior and answer information input by the user with respect to the question information;
the server device is configured to perform:
performing communication with the in-vehicle device;
performing evaluation on the driver based on the behavior information and the answer information;
performing the evaluation a plurality of times based on a distance from a departure place to a destination of the vehicle or a scheduled required time;
selecting first content based on a result of the evaluation and selecting second content according to the driving actions of the driver before and after receiving provision of the first content;
providing the first content if the first content is selected and the second content if the second content is selected to the driver;
providing a first message praising the driver in a case where the result of the evaluation is higher than a reference value defined in advance or in a case where the result of the evaluation after receiving the provision of the first content improved than before receiving the provision of the first content; and
providing a second message encouraging the driver to improve the driving action in a case where the result of the evaluation is lower than the reference value or in a case where the result of the evaluation after receiving the provision of the first content is worse than before receiving the provision of the first content, wherein
the in-vehicle device is further configured to perform:
through the communication, transmitting the first content, the second content, the first message, or the second message to the second communication terminal, wherein
the first content, the second content, the first message, and the second message are output by at least one of the second communication terminal, the in-vehicle device, and the server device.

5. The driving evaluation system according to claim 2, wherein
the in-vehicle device is further configured to perform:
providing an incentive to the user who has input the answer information used at the time of selecting the first content to the first communication terminal in a case where the result of the evaluation improved after receiving the provision of the first content; and
through the communication, transmitting information indicating the incentive to the first communication terminal.

6. The driving evaluation system according to claim 2, wherein
the in-vehicle device is further configured to perform:
setting a first timing for transmitting the question information and a second timing for transmitting the first content or the second content a plurality of times in correspondence with a timing of the evaluation.

7. The driving evaluation system according to claim 6, wherein
the in-vehicle device is configured to set a number of times of the evaluation to one if the distance is equal to or less than a predetermined distance or the scheduled required time is within a predetermined time, and limit each of the first timing and the second timing to one in a case where the number of times of the evaluation is one.

8. The driving evaluation system according to claim 1, wherein
the in-vehicle device is configured to perform the evaluation based on a comparison result between the behavior of the vehicle and the answer information of the user to the question information.

9. The driving evaluation system according to claim 1, wherein
the in-vehicle device is configured to cancel the evaluation in a case where the behavior information is not received from the first communication terminal or in a case where a reliability of the behavior information received from the first communication terminal is lower than a predetermined value.
